(19) United States
(12) Patent Application Publication
(10) Pub. No.: US 2017/0036365 A1
(43) Pub. Date: Feb. 9, 2017

(54) SHEET MATERIAL CUTTING GUIDE AND RULER

(71) Applicant: Gary DARWIN, Sunburst, MT (US)

(72) Inventor: Gary DARWIN, Sunburst, MT (US)

(21) Appl. No.: 15/098,413

(22) Filed: Apr. 14, 2016

Related U.S. Application Data
(60) Provisional application No. 62/200,795, filed on Aug. 4, 2015.

(51) Int. Cl. B26B 29/06

(52) U.S. Cl. CPC B26B 29/06

(57) ABSTRACT

A sheet material cutting guide and ruler may have a substantially transparent body with marked measurement designations on a first face and a depression on an opposing second face that may create a track. The body may have an open void channel that is centered within the track and runs length vise in parallel with the track. A glide may freely travel along the second face of the sheet material cutting guide within the track. The glide may have a quick connect and disconnect attachment device fixed to the glide that may travel freely within the channel when disconnected. The attachment device may secure the glide to the body of the sheet material cutting guide and ruler in a connected position. The glide may have a marked designation that may be superimposed with the line markings of the first face to cut a measured sheet material.

### PRIORITY

This application claims priority to U.S. Provisional Application No. 62/200,795, filed Aug. 4, 2015, the contents of which are herein incorporated by reference.

### BACKGROUND

Sheet-like materials such as fabric and other textiles are produced in a variety of sizes, lengths, textures, and compositions of matter. These materials are typically sold in lengthy segments with the intention of being further modified into custom lengths, sizes, angles, and shapes. Sheet-like material may be cut with rotary tools, razors, scissors, and other similarly situated devices. It may be difficult to cut these materials into precise lengths, sizes, angles, and shapes. Additionally, it may be difficult to cut multiple pieces of fabric simultaneously and safely.

### SUMMARY

According to an exemplary embodiment, a sheet material cutting guide and ruler may be provided. The sheet material cutting guide and ruler may have an elongated ruler body having a top face and a bottom face. There may be a plurality of measurement markings disposed on the top face. A track may be disposed in the bottom face and the track may be a depression run the length of the elongated ruler body. The track may have open longitudinal ends. The ruler may further have a channel disposed through the ruler body parallel to and within the track. The channel may run a portion of the length of the track. A glide may be disposed within the track and may have a width and depth corresponding to the width and depth of the track. The glide may be capable of sliding along the length of the track. A glide attachment may slidably secure the glide to the channel.

According to another exemplary embodiment, a method of cutting a strip of material may be provided. The method may include providing a strip of material to be cut. A cutting guide and ruler may further be provided. The cutting guide and ruler may have a track of corresponding size to the strip of material. The cutting guide and ruler may have an elongated ruler body with a top face and a bottom face. There may be a plurality of measurement markings disposed on the top face. A track may be disposed in the bottom face and the track may be a depression running the length of the elongated ruler body. The track may have open longitudinal ends. The ruler may further have a channel disposed through the ruler body parallel to and within the track. The channel may run a portion of the length of the track. A glide may be disposed within the track and may have a width and depth corresponding to the width and depth of the track. The glide may be capable of sliding along the length of the track. A glide attachment may slidably secure the glide to the channel. The glide may be secured at a desired position within the track corresponding to a desired length of the material to be cut. The material may be placed within the track, abutting an end of the glide. The material may be cut along a longitudinal end of the ruler body.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

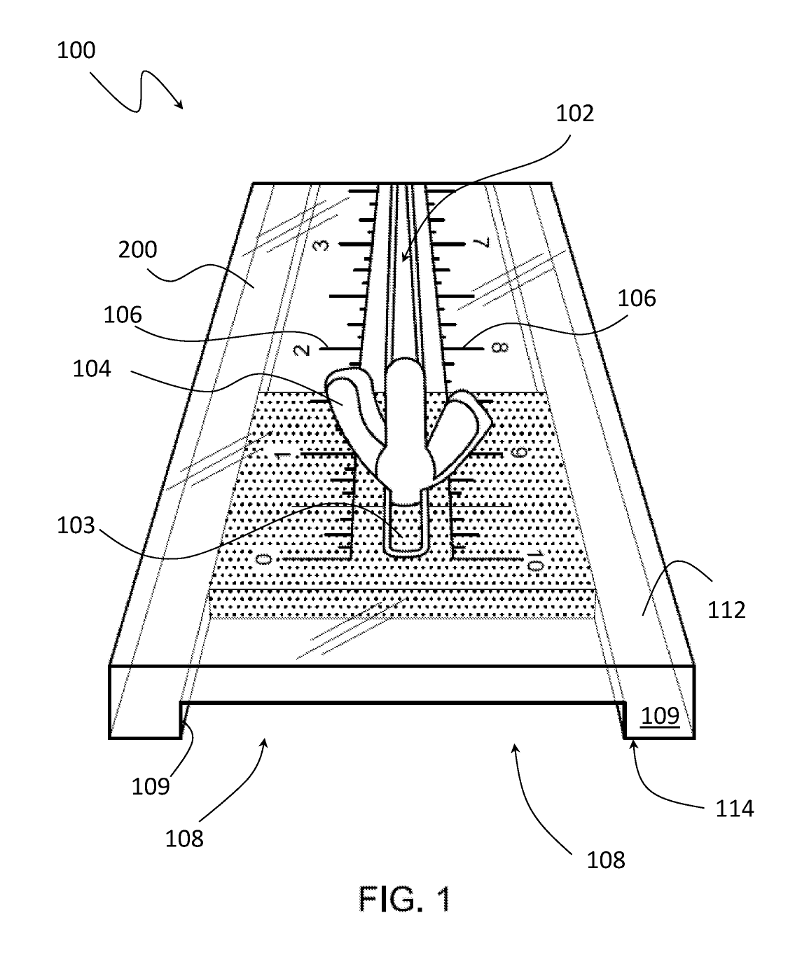

Exemplary FIG. 1 may show a close up of a sheet material cutting guide and ruler;

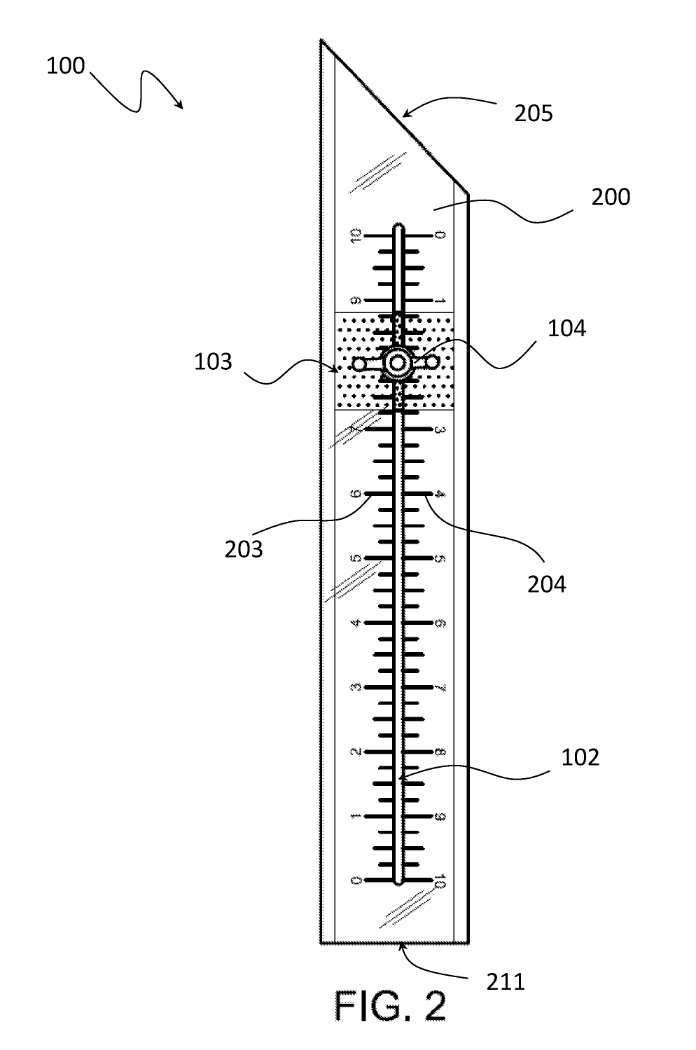

Exemplary FIG. 2 may show a sheet material cutting guide and ruler;

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, a sheet material cutting guide and ruler may be described. The sheet material cutting guide and ruler may be used to cut sheet materials into a variety of sizes and shapes from pre-manufactured sheet materials. Additionally, the sheet material cutting guide and ruler may be a fluorescent color, transparent, or substantially solid colored. The sheet material cutting guide and ruler may have a marked ruler body on a top face and a depression on an opposing bottom face thereby creating a track on the bottom face. The sheet material cutting guide may have an open void channel that is centered within the track and runs lengthwise in parallel with the track. A glide may freely travel along the bottom face of the sheet material cutting guide within the track. The glide may have a fastener, pin, screw, or other similarly situated quick connect and quick disconnect attachment device. In an exemplary embodiment, the attachment device may include a screw or bolt and corresponding nut or wingnut. The attachment device may be fixed to the glide, travel freely within the channel when disconnected and securely couple to the sheet material cutting guide and ruler such that the glide is secured in a fixed position when in a connected position. The glide may have any number of marked designations at any number of repeating or non-repeating intervals with intervals occurring at any size. The marked measurement designations may be visible through a transparent first face of the sheet material cutting guide and ruler. Additionally the glide may be visible through the transparent ruler body. The body may have any number of marked designations at any number of repeating or non-repeating intervals with intervals occurring at any size. The line measurement markings of the first face may be superimposed with the marked measurement designations of the glide. When the line measurement markings are superimposed a sheet like material may abut the glide on the underside of the first face. When the sheet like material abuts the glide, a cutting device may cut the sheet like material along either an angled or straight edge thereby utilizing the edge as a corresponding cutting guide. Additionally, the superimposed line markings of the glide and first face may serve as an accurate measurement of the length of the finished sheet material after it has been cut.

Referring to FIG. 1, an exemplary embodiment of a sheet material cutting guide and ruler 100 may be provided. The sheet material cutting guide and ruler 100 may have a top face and a bottom face. The sheet material cutting guide and ruler 100 may be substantially transparent. The bottom face may have a depression, thereby creating a track 108, which may run lengthwise and in parallel with the edges of the sheet material cutting guide and ruler 100. Sidewalls 109 may run along the sides of track 108 and may optionally be formed integral to a ruler body or may be affixed to the bottom face of the ruler body 200. Sidewalls 109 may extend from the widths of the track to the width of the ruler body 200. The sheet material cutting guide and ruler 100 may have a glide 103 that may be substantially contained within the track 108 by abutting the sidewalls 109 of the track 108. The glide 103 may have a thickness correspondent to the thickness of the track 108, such that the sidewalls 109 and glide 103 form a level bottom of the ruler 100. The sheet material cutting guide and ruler 100 may have an open void channel 102 which may run coaxially with the track 108. The glide may uniformly slide lengthwise down the bottom face of the sheet material cutting guide and ruler within the track 108. The glide may be assisted in uniformly sliding lengthwise down the bottom face of the sheet material cutting guide and ruler by the attachment device 104 and channel 102.

In some exemplary embodiments, the attachment device 104 may be fixed to the glide 103. When the glide 103 is positioned within the track 108 a portion of the attachment device may be contained within the channel 102 and a portion of the attachment device may extend beyond the channel 102. The attachment device 104, may have a closed secured position and open unsecured position. The glide 103 may freely and uniformly slide lengthwise down the bottom face of the sheet material guide and ruler when the attachment device 104 is in an open unsecured position. Alternatively, the glide 103 may be secured in a fixed location on the bottom face of the sheet material cutting guide and ruler when the attachment device 104 is in a closed secured position. The glide 103 may have measurement markings 106 that may assist in positioning the glide in a desired location or position. The measurement markings 106 may be marked on a left side and a right side of a top face of the glide 103. The measurement markings may increase proportionally by ¼″ and ⅛″ markings or any desired measurement increment. Additionally, the measurement markings may increase proportionally in alternating directions thereby allowing a user to read the measurement markings 106 of the glide 103 when the sheet material cutting guide and ruler is positioned in any orientation. For example, there may optionally be two sets of measurement markings 106, which may progress in opposite directions. In an exemplary embodiment, the sets of measurement marks may be on opposite sides of the open void channel. In other exemplary embodiments, the sets of measurement marks may be located as desired on the ruler 100.

Referring to FIG. 2, the sheet material cutting guide and ruler 100 may have a body 200, an angled end 205 and a straight end 211. The angled end 205 may optionally be at a 45 degree angle in reference to an adjoining side of the body 205. The angled end 205 may alternatively be at any desired angle, as would be understood by a person having ordinary skill in the art. The straight end 211 may be at a 90 degree angle in reference to an adjoining side of the body 200. The angled end 205 and the straight end 211 may be used as a guide for a cutting tool. In some exemplary embodiments, the cutting tool may be a knife, rotary blade cutting tool, or other comparable cutting device as would be understood by a person having ordinary skill in the art. The sheet material cutting guide and ruler may have left side marked measurements 203 and right side marked measurements 204. The left side marked measurements 203 and the right side marked measurements 204 may incrementally increase and decrease in opposing directions such that the starting measurement of the left side marked measurements is the ending measurement of the right side marked measurements 204. In some exemplary embodiments, the left side marked measurements 203 and the right side marked measurements 204 of the sheet material cutting guide and ruler may have numbered designations from 0″ to any desired length, such as 10″, in 1″ intervals. Alternatively, the numbered designations may be at any number of repeating or non-repeating intervals with intervals occurring at any desired size, as would be understood by a person having ordinary skill in the art.

Additionally, the left side marked measurements 203 and the right side marked measurements 204 of the sheet material cutting guide may have multiple line markings between the aforementioned number designations. In an exemplary embodiment, these markings may further segment the measurements markings into ¼″ and ⅛″ intervals. Alternatively, the line markings may be at any number of repeating or non-repeating intervals with intervals occurring at any size. Furthermore, the left side marked measurements 203 and the right side marked measurements 204 may have marked measurements that correspond to metric or standard international units of measurement. The glide 103 may have a left and right side marked measurement line for aligning with the left side marked measurements 203 and the right side marked measurements 204. In some exemplary embodiments, glide 103 may have multiple left and right side marked measurements. The sheet material cutting guide and ruler 100 may be any desired length and corresponding width as would be understand by a person having ordinary skill in the art. For example, the sheet material cutting guide and ruler may be well suited for the following size tracks; 1.5″ wide track, 2.5″, 3.5″ and 4.5″. Other size tracks are contemplated as they would be understood by a person having ordinary skill in the art. The body 200 of the sheet material cutting guide and ruler and the glide 103 may be substantially transparent. The body 200 and the glide 103 may be differing colors. For example the body 200 may be a substantially transparent fluorescent green and the glide 103 may be a substantially transparent fluorescent orange. The measurement markings of glide 103 may be visible through the substantially transparent body 200. The glide may be positioned into a pre-determined location by superimposing the left side marked measurements 203 or the right side marked measurements 204 with the corresponding marked measurements of the glide 103. When the marked measurements are superimposed a sheet material may be cut at a specific length which corresponds to the superimposed marked measurements. In some exemplary embodiments, the edges of glide 103, which may be viewed through the transparent body 200, may optionally be used as glide measurement markings for alignment with measurement markings on the body 200. In operation, a sheet material may be inserted in the track 108 on the underside of body 200 and may be abutted against an edge of the glide 103. The superimposed marked measurements may indicate the length a sheet material may be cut when a cutting tool abuts the straight end 211 or the angled end 205 of the body as a cutting guide. The ruler 100 may be selected with a track width matching a desired sheet material width to be cut. A user may cut along straight end 211 or angled end 205 to create a strip of a desired length having a correspondingly straight end or an angled end.

According to an exemplary embodiment a method for cutting sheet-like materials may be provided. The sheet-like material may be cut by a cutting device utilizing a sheet material cutting guide and ruler as an assistive device. The material may already be in strips having a width corresponding to the width of the track of a sheet material cutting guide and ruler. In an exemplary embodiment where the cutting guide and ruler has a 2.5″ wide track, the sheet like material cutting guide and ruler may be set to a desired size such as a 2.5″ square. Therefore, the cutting guide and ruler may be used to cut the 2.5″ wide strips of material into 2.5″ squares. The versatility of the sheet material cutting guide and ruler may allow the placement and cutting of multiple layers of fabric at a given time. The sheet like material cutting guide and ruler may hold the fabric in place by placing the fabric underneath the body of the device within the track. A downward pressure may optionally be applied to secure material. Optional ridges or adhesive strips on the underside of the sheet material cutting guide and ruler may assist in retaining the fabric or sheet material in a desired location. The sheet material cutting guide and ruler may be used as a guide to cut substantially exact pre-determined measurements of sheet-like material by positioning and securing the glide in a measurement location, placing a sheet like material underneath the device within the track, abutting the sheet like material against the glide, and utilizing the end of the device as a guide for a cutting device. The sheet material cutting guide and ruler may be used for making accurate cuts of quilt fabrics. The sheet material cutting guide and ruler may be used to cut up, for example, Jelly Rolls, Bali Pops, Story Strips, and Roll Ups. The sheet material cutting guide and ruler may be used to cut up sheet material into a variety of shapes, such as diamonds, trapezoids, parallelograms, rectangles, squares, and other shapes as would be understood by a person having ordinary skill in the art.

In some further exemplary embodiments, a gripping substance or material may be applied to the surface of ruler 100 to securely retain sheet material or fabric in a desired orientation for cutting.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A sheet material cutting guide and ruler comprising:
an elongated ruler body having a top face and a bottom face;
a plurality of measurement markings disposed on the top face;
a track disposed in the bottom face, wherein the track is a depression running the length of the elongated ruler body and having open longitudinal ends;
a channel disposed through the ruler body parallel to and within the track, the channel running a portion of the length of the track;
a glide disposed within the track having a width and depth corresponding to the width and depth of the track, wherein the glide is configured to slide along the length of the track; and
a glide attachment slidably securing the glide to the channel.

2. The cutting guide and ruler of claim 1, wherein the glide attachment has a tightened orientation for securing the glide in a desired position along the channel and a loosened orientation to allow the glide to slide within the track along the length of the channel.

3. The cutting guide and ruler of claim 1, further comprising a sidewall running parallel along each lengthwise side of the track.

4. The cutting guide and ruler of claim 3, wherein the sidewalls form the depth of the track.

5. The cutting guide and ruler of claim 1, further comprising a first longitudinal end being square to the track.

6. The cutting guide and ruler of claim 1, further comprising a second longitudinal end being angled to the track.

7. The cutting guide and ruler of claim 1, wherein the glide attachment comprises a bolt and nut.

8. The cutting guide and ruler of claim 1, further comprising sets of measurement markings running from opposing longitudinal ends of the ruler body.

9. The cutting guide and ruler of claim 1, wherein the ruler body is transparent.

10. The cutting guide and ruler of claim 9, wherein the glide is visible through the ruler body and is configured to align with the measurement markings.

11. The cutting guide and ruler of claim 1, wherein the track is configured to receive a material to be cut and a longitudinal end of the ruler body is configured to guide a cutting tool.

12. A method of cutting a strip of material comprising:
providing a strip of material to be cut;
providing a cutting guide and ruler having a track of corresponding size to the strip of material, wherein the cutting guide and ruler comprises an elongated ruler body having a top face and a bottom face, a plurality of measurement markings disposed on the top face, a track disposed in the bottom face, wherein the track is a depression running the length of the elongated ruler body and having open longitudinal ends, a channel disposed through the ruler body parallel to and within the track, the channel running a portion of the length of the track, a glide disposed within the track having a width and depth corresponding to the width and depth of the track, wherein the glide is configured to slide along the length of the track, and a glide attachment slidably securing the glide to the channel;
securing the glide at a desired position within the track corresponding to a desired length of the material to be cut;
placing the material to be cut within the track, abutting an end of the glide; and
cutting the material along a longitudinal end of the ruler body.

13. The method of claim 12, wherein the ruler body comprises an angled longitudinal end and a square longitudinal end.

14. The method of claim 13, further comprising selecting the angled end or the square end for the material to be correspondingly cut along.

15. The method of claim 13, further comprising securing the glide at a desired position for cutting the material along the square end or the angled end of the ruler body; inserting the material into the track on the selected end; and cutting along the selected end.
